(19) United States
(12) Patent Application Publication
(10) Pub. No.: US 2025/0249657 A1
(43) Pub. Date: Aug. 7, 2025

(54) PREPARATION METHOD OF NATURAL BAMBOO FIBER COMPOSITES AND APPLICATION THEREOF

(71) Applicant: SAIC GM Wuling Automobile CO., Ltd, Liuzhou (CN)

(72) Inventors: Wei LI, Liuzhou (CN); Xiaobin ZHAO, Liuzhou (CN); Mengdie DENG, Liuzhou (CN); Binbin YU, Liuzhou (CN); Min WEI, Liuzhou (CN); Zheng JIANG, Liuzhou (CN); Yongping ZHU, Liuzhou (CN); Xiaolan MA, Liuzhou (CN)

(73) Assignee: SAIC GM Wuling Automobile CO., Ltd, Liuzhou (CN)

(21) Appl. No.: 18/633,431

(22) Filed: Apr. 11, 2024

(30) Foreign Application Priority Data
Feb. 1, 2024 (CN) 2024101448447
Mar. 26, 2024 (CN) 2024103544627

(51) Int. Cl. B32B 5/26; B32B 1/00; B32B 3/26; B32B 3/30; B32B 7/09; B32B 37/10; B32B 38/00; B32B 38/04; B32B 38/16

(52) U.S. Cl. CPC B32B 5/266; B32B 1/00; B32B 3/266; B32B 3/30; B32B 7/09; B32B 37/10; B32B 38/0012; B32B 38/0036; B32B 38/04; B32B 38/162; B32B 38/164; B32B 2038/0064; B32B 2038/042; B32B 2250/02; B32B 2250/20; B32B 2262/0253; B32B 2262/0284; B32B 2262/065; B32B 2262/144; B32B 2305/20; B32B 2307/54; B32B 2307/718; B32B 2307/7376; B32B 2309/025; B32B 2309/125; B32B 2310/0409; B32B 2317/10; B32B 2323/10; B32B 2367/00; B32B 2605/08

(57) ABSTRACT

The present invention provides a preparation method of natural bamboo fiber composites and an application thereof. The method involves treating bamboo with a specific composition of treatment solution to obtain natural bamboo fibers with a length and a diameter that meets certain conditions; then, the natural bamboo fibers are combined with polypropylene fibers to prepare composites, and by controlling process conditions of a preparation process, a high-strength and excellent comprehensive performance composites is finally prepared. The composites produced by the method can be used as a bottom baffle of the air conditioning box in automobiles. Through the method, a high-performance natural bamboo fiber composites are provided.

### CROSS-REFERENCE TO RELATED APPLICATIONS

The application claims priority to Chinese patent application No. 2024101448447, filed on Feb. 1, 2024; and Chinese patent application No. 2024103544627, filed on Mar. 26, 2024, the entire contents of which are incorporated herein by reference.

### TECHNICAL FIELD

The present invention relates to a field of composite material technology, and more particular to a preparation method of natural bamboo fiber composites and an application thereof.

### BACKGROUND

Bamboo fiber refers to the primary fibers directly separated from bamboo stems through mechanical and physical processes, as well as chemical and biological methods. Natural bamboo fiber is provided with good breathability, instant deionized water absorption, and strong wear resistance. At the same time, it has functions of natural antibacterial, bacterial inhibition, mite removal, odor prevention, and UV resistance. It has attracted attention due to so many advantages, and gradually become a popular material choice.

In prior art, the patent invention text with invention number 201810145083.1 and publication date of Jun. 12, 2018, titled “Preparation method of natural fiber reinforced composites”, effectively reduces the porosity and defects inside the natural fiber reinforced composites by mixing natural fibers and thermoplastic resin fibers to make felt, and using step pressure in the forming process to squeeze the air inside the prefabricated component in two stages, produce composites with excellent mechanical properties. Although the composites produced by the above technical solution is superior to a single resin fiber or a natural fiber in terms of performance, such as a maximum strength of the composites is about 70 MPa, the composites cannot meet the application requirements for application scenarios with high strength requirements. This may be due to inadequate treatment during the preparation of natural fibers, resulting in insufficient removal of impurities in the fibers, which affects the performance of the fibers.

In view of this, it is necessary to design an improved preparation method and application of natural bamboo fiber composites to solve the above problems.

### SUMMARY

The objects of the present invention is to provide a preparation method of natural bamboo fiber composites and an application thereof.

In order to achieve the objects, in one aspect, the present invention provides a preparation method of natural bamboo fiber composites, comprising following steps:
S1. preparing a treatment solution including sodium hydroxide, sodium silicate, sodium sulfite, composite sodium phosphate, and sodium carbonate; and
S2. cutting a bamboo into bamboo slices, then soaking the bamboo slices in the treatment solution obtained in step S1 for 5-7 days; taking out the bamboo slices after soaking, immersing in a sodium hydroxide solution with a mass percentage of 4-10%, and heating at 70-100 degree for 1-3 hours; adding an acetic acid to a pH of 6.8-7.2 after heating, taking out the bamboo slices, cleaning and drying, then separating manually to obtain natural bamboo fibers; and
S3. mixing the natural bamboo fibers obtained in step S2 with polypropylene fibers evenly, using a process of opening, carding, lapping and needle-punching to produce a natural bamboo fiber felt material; then laying a fabric on a surface of the natural bamboo fiber felt material, and using a secondary needle-punching process to produce a natural bamboo fiber composite felt; after heating to soft the natural bamboo fiber composite felt, pressing into shape to produce natural bamboo fiber composites.

As an embodiment of the present invention, in step S1, a mass concentration of sodium hydroxide in the treatment solution is 8-12 g/L, a mass concentration of sodium silicate is 1-4 g/L, a mass concentration of sodium sulfite is 1-4 g/L, a mass concentration of composite sodium phosphate is 1-4 g/L, and a mass concentration of sodium carbonate is 1-4 g/L.

As an embodiment of the present invention, in step S2, an average length of a single bamboo fiber is 150-250 mm, and a diameter is 0.2-0.3 mm.

As an embodiment of the present invention, in step S2, a breaking strength of a single bamboo fiber is 2000-3000 Mpa, and an elongation at break is 5-7%.

As an embodiment of the present invention, in step S3, a heating temperature is 200-230° C. and a heating time is 3-7 minutes; a mass ratio of the natural bamboo fibers to the polypropylene fibers is 2:3-3:2.

As an embodiment of the present invention, in step S3, a pressure during the pressing process is 16-20 Mpa, and a pressing time is 30-50 s.

As an embodiment of the present invention, in step S3, a density of the natural bamboo fiber felt material is 600-1200 g/m²; a thickness of the natural bamboo fiber composite felt is 8-15 mm.

A preparation method proposed by the present invention can be used to produce the natural bamboo fiber composites.

In another aspect, the present invention also provides an application of the natural bamboo fiber composites in a bottom baffle of an air conditioning box in automobiles.

As an embodiment of the present invention, a bottom baffle of an air conditioning box in automobiles is provided, comprising the natural bamboo fiber composites proposed in the present invention.

The beneficial effects of the present invention are:

1. The preparation method of the natural bamboo fiber composites provided by the present invention involves treating bamboo with a specific composition of treatment solution to obtain bamboo fibers with a length and a diameter that meets certain conditions; then, the above-mentioned bamboo fibers are combined with polypropylene fibers to prepare composites, and by controlling process conditions of the preparation process, a high-strength and excellent comprehensive performance composites is finally prepared.

2. The preparation method of the natural bamboo fiber composites provided by the present invention, starting from an extraction process of bamboo fibers and a process flow of composites preparation, selecting best preparation conditions, and producing composites with excellent performances; By selecting bamboo fibers as a raw material, it not only has a wide range of sources but also excellent performance. The composites made by combining it with polypropylene fibers can fully utilize the high strength, moisture absorption and dehumidification, sound absorption, and lightweight characteristics of bamboo fibers. When used as a bottom baffle of an air conditioning box in automobiles, the high strength of the composites ensures the overall stability of the material, the sound absorption and moisture absorption and dehumidification characteristics of the composites effectively reduce a noise inside the car and maintain a comfortable and clean environment, creating the comfortable environment for the car with strong practicality.

### BRIEF DESCRIPTION OF DRAWINGS

FIG. 1 is a physical image of the bottom baffle of an air conditioning box produced in embodiment 1 of the present invention;

FIG. 2 is a SEM image of the bottom baffle of an air conditioning box produced in embodiment 1 of the present invention.

### DETAILED DESCRIPTION OF THE EMBODIMENTS

In order to clarify the purpose, technical solution, and advantages of the present invention, a detailed description of the present invention will be provided below in conjunction with the drawings and specific embodiments.

It should also be noted that in order to avoid blurring the present invention due to unnecessary details, only the structures and/or processing steps closely related to the scheme of the present invention are shown in the drawings, and other details that are not closely related to the present invention are omitted.

Furthermore, it should also be noted that terms “comprising”, “including”, or any other variations thereof are intended to encompass non exclusive inclusion, Thus a process, method, item, or equipment that includes a series of elements not only includes those elements, but also includes other elements that are not explicitly listed, or also includes elements inherent to the process, the method, the item, or the equipment.

In one aspect, the present invention provides a preparation method of natural bamboo fiber composites, comprising following steps:
S1. preparing a treatment solution: the treatment solution includes sodium hydroxide, sodium silicate, sodium sulfite, composite sodium phosphate, and sodium carbonate; a specific preparation method of the treatment solution is as follows: Mixing the sodium hydroxide, the sodium silicate, the sodium sulfite, the composite sodium phosphate, the sodium carbonate with deionized water evenly to obtain the treatment solution; and
S2. extracting natural bamboo fibers: cutting a bamboo into bamboo slices, then soaking the bamboo slices in the treatment solution obtained in step S1 for 5-7 days; taking out the bamboo slices after soaking, immersing in a sodium hydroxide solution with a mass percentage of 4-10%, and heating at 70-100 degree for 1-3 hours; adding an acetic acid to a pH of 6.8-7.2 after heating, taking out the bamboo slices, cleaning and drying, then separating manually to obtain natural bamboo fibers; and
S3. preparing of natural bamboo fiber composites: mixing the natural bamboo fibers obtained in step S2 with polypropylene fibers evenly, using a process of opening, carding, lapping and needle-punching to produce a natural bamboo fiber felt material; then laying a fabric on a surface of the natural bamboo fiber felt material, and using a secondary needle-punching process to produce a natural bamboo fiber composite felt; after heating to soft the natural bamboo fiber composite felt, pressing into shape to produce a natural bamboo fiber composites.

In the above process, by combining the bamboo fibers obtained through special treatment with polypropylene fibers to prepare composites, the high strength, moisture absorption and dehumidification, thermal insulation, sound insulation and other properties of bamboo fibers can be fully utilized, and can be used to shape the bamboo fibers in the composites. By adjusting the ratio of natural bamboo fibers to polypropylene fibers, a bending strength and a bending performance of the composites can be controlled. When the ratio of the two is 5:5, the adhesive force inside the composites is optimal, and a comprehensive performance of the composites is the best.

As an embodiment of the present invention, in step S1, the mass concentration of sodium hydroxide in the treatment solution is 8-12 g/L, the mass concentration of sodium silicate is 1-4 g/L, the mass concentration of sodium sulfite is 1-4 g/L, the mass concentration of composite sodium phosphate is 1-4 g/L, and the mass concentration of sodium carbonate is 1-4 g/L. In some embodiments, the treatment solution is prepared by dissolving 8-12 g sodium hydroxide, 1-4 g sodium silicate, 1-4 g sodium sulfite, 1-4 g composite sodium phosphate, and 1-4 g sodium carbonate in 1 L deionized water and mixing evenly, wherein, the composite sodium phosphate is one or more of sodium tripolyphosphate, sodium hexametaphosphate, sodium pyrophosphate, trisodium phosphate, disodium hydrogen phosphate, sodium dihydrogen phosphate, sodium acid pyrophosphate, and disodium dihydrogen pyrophosphate.

In the above process, a degree of alkaline degradation of a pectin, a lignin, and a hemicellulose in bamboo slices is controlled by adjusting the amount of sodium hydroxide added to the treatment solution, thereby avoiding a decrease in the tensile strength of natural bamboo fibers during the bamboo slice treatment process. By adding sodium silicate as a degumming enhancer, the combination of sodium silicate with pectin, lignin, and hemicellulose can be utilized to decompose the gum in bamboo chips. By adding sodium sulfite and composite sodium phosphate as antioxidant agents, the oxidation failure of bamboo fibers can be prevented. By adding sodium carbonate as a bleaching agent, some pigments in bamboo fibers can be removed to achieve the bleaching effect.

As an embodiment of the present invention, in step S2, an average length of a single bamboo fiber is 150-250 mm, and a diameter is 0.2-0.3 mm, a breaking strength is 2000-3000 Mpa, and an elongation at break is 5-7%. Bamboo fibers that meets the above conditions is more conducive to process when applying to a bottom baffle of an air conditioning box in automobiles, and the composites is provided with excellent performances, and meeting the requirements for material performance in the usage environment.

As an embodiment of the present invention, in step S2, a ratio of a mass of bamboo slices (kg) to a volume of the treatment solution (L) during the soaking process is 1:40-1:50.

As an embodiment of the present invention, in step S3, a mass ratio of the natural bamboo fibers to the polypropylene fibers is 2:3-3:2.

As an embodiment of the present invention, in step S3, the fabric is specifically a PET non-woven fabric, and the following relationship is satisfied between the mass (g) of the natural bamboo fiber felt material and the area (m²) of the PET non-woven fabric: 600-1000 g of the natural bamboo fiber felt material is added to every 1 m² of PET non-woven fabric. By adding PET non-woven fabric, its own strength characteristics and water repellent properties can be used to provide composites excellent performance, while achieving surface decoration and improving quality of composites.

As an embodiment of the present invention, in step S3, a heating temperature is 200-230° C. and a heating time is 3-7 minutes. By controlling the heating temperature within the above range, the performances of the composites can be regulated; When the heating temperature is less than 200° C., the composites does not soft enough and the product is difficult to form. When the heating temperature is above 230° C., the natural bamboo fibers are prone to carbonization, causing damage to internal structure and affecting the mechanical properties of the materials.

As an embodiment of the present invention, in step S3, a pressure during the pressing process is 16-20 Mpa, and a pressing time is 30-50 s.

As an embodiment of the present invention, in step S3, a density of the natural bamboo fiber felt material is 600-1200 g/m²; a thickness of the natural bamboo fiber composite felt is 8-15 mm.

The following will further explain the preparation method and application of the natural bamboo fiber composites of the present invention with specific implementation examples:

### Embodiment 1

The embodiment has prepared a natural bamboo fiber composites, comprising the following method:
S1. dissolving 60 g of sodium hydroxide, 20 g of sodium silicate, 20 g of sodium sulfite, 20 g of composite sodium phosphate, and 20 g of sodium carbonate in 5 L of deionized water, mixing evenly, obtaining a treatment solution; in this embodiment, the composite sodium phosphate is specifically sodium pyrophosphate; and
S2. cutting a bamboo into bamboo slices, then soaking the bamboo slices in the treatment solution obtained in step S1 for 6 days; taking out the bamboo slices after soaking, immersing in a sodium hydroxide solution with a mass percentage of 8%, and heating at 100 degree for 1.5 hours; adding acetic acid to a pH of 7 after heating, taking out the bamboo slices, cleaning and drying, then separating manually to obtain natural bamboo fibers; and
S3. preparing natural bamboo fiber composites: mixing the natural bamboo fibers obtained in step S2 with polypropylene fiber evenly in a 5:5 mass ratio, using a process of opening, carding, lapping and needle-punching to produce a natural bamboo fiber felt material; according to an addition amount of 1000 g of the natural bamboo fiber felt material for 1 m² PET non-woven fabric, the area of PET non-woven fabric is first determined according to a quality of the natural bamboo fiber felt material, and then laying the PET non-woven fabric on a surface of the natural bamboo fiber felt material, and using a secondary needle-punching process to produce a natural bamboo fiber composite felt with a density of 1200 g/m², a thickness of the natural bamboo fiber composite felt is 8 mm. After heating at 220° C. for 5 minutes to soft the natural bamboo fiber composite felt, pressing for 30 seconds under a pressure of 20 Mpa to form the felt, thus the natural bamboo fiber composites are produced. It should be noted that the reagents and raw materials used in the present invention can be purchased from market unless otherwise specified.

Specifically, in this embodiment, the composites mentioned above is further used as a bottom baffle of an air conditioning box in automobiles. Therefore, a molding process can be assisted by a mold of the bottom baffle of the automobile air conditioning box. The process only needs to be selected according to actual needs, so a shape of the bottom baffle of the automobile air conditioning box is not limited here. It should be noted that in other embodiments, the composites can also be made into other automotive interior decorations.

After tests, a bending modulus of the composites prepared in this embodiment is 3152 Mpa, which is significantly higher than a 1800 Mpa of the polypropylene fibers. When the composites prepared by the method of this embodiment is used as the bottom baffle of the automobile air conditioning box, there are gaps of different sizes on the cross-section of the natural bamboo fibers, and there are several small micro grooves on the surface. These grooves and gaps can used as capillaries to absorb and evaporate water quickly, which is conducive to keep the bottom baffle in a dry state and can also absorb the noise inside the car.

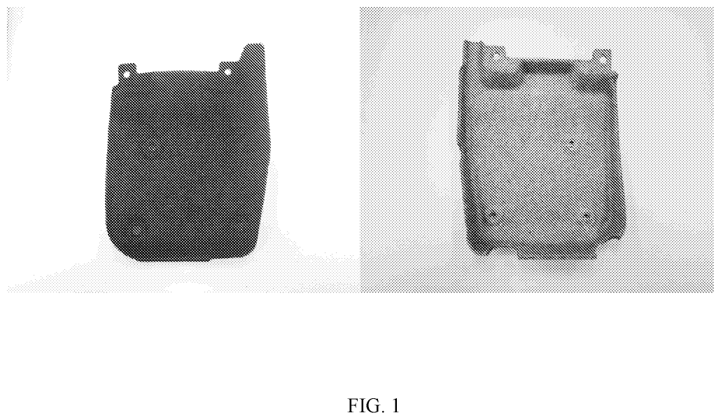

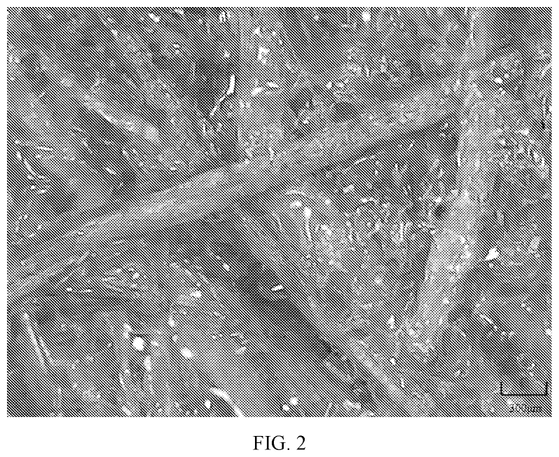

The physical image of an bottom baffle of an automobile conditioning box prepared in embodiment 1 is shown in FIG. 1, and the SEM image is shown in FIG. 2.

### Embodiment 2 to 6

The only difference between Embodiment 2 to 6 and Embodiment 1 is that the composition of the treatment solution used in step S2 is different with Embodiment 1, that is, the concentration of each components in the treatment solution is mainly changed, and other steps are the same as Embodiment 1, which will not be repeated here. The composition of the treatment solution in Embodiment 1 to 6 and the performance comparison of the composites prepared under corresponding conditions are shown in Table 1. It can be seen from the table that at a low concentration, a weight loss rate of the bamboo slices increases with the increase of sodium hydroxide concentration. In the treatment solution, the pectin, lignin, and hemicellulose of the bamboo chips undergo alkaline degradation, resulting in weight loss. The weight loss rate reaches 45-55% in a 12 g/L sodium hydroxide solution. Continuing to increase the concentration of sodium hydroxide solution afterwards does not have a significant effect on increasing the weight loss rate, but causing a decrease in the tensile strength of the natural bamboo fibers. Sodium silicate, as a degumming enhancer, can combine with pectin, lignin, and hemicellulose to decompose the gum of bamboo chips. Sodium sulfite and composite sodium phosphate, as antioxidant agents, can prevent oxidation failure of bamboo fibers, the composite sodium phosphate in these embodiments of this part is specifically sodium pyrophosphate. As a bleaching agent, sodium carbonate can remove some pigments from bamboo fibers to achieve the effect of bleaching. The concentration of these inorganic salts also has a significant impact on the weight loss rate of bamboo slices. Within the range of formula proportions, the weight loss rate of bamboo slices increases with the increase of inorganic salt concentration, and the weight loss rate increases by 30-50%. After exceeding the formula concentration, there is no significant change in the weight loss rate of bamboo slices.

TABLE 1
Composition of the treatment solution in Embodiment 1 to 6 and performance
comparison of the composites prepared under corresponding conditions

| | | | | composite | | weight loss | bending |
|---|---|---|---|---|---|---|---|
| | sodium | sodium | sodium | sodium | sodium | rate of | modulus of |
| | hydroxide | silicate | sulfite | phosphate | carbonate | bamboo fibers | composites |
| items | (g/L) | (g/L) | (g/L) | (g/L) | (g/L) | (%) | (Mpa) |
| Embodiment 1 | 12 | 4 | 4 | 4 | 4 | 55 | 3152 |
| Embodiment 2 | 10 | 4 | 4 | 4 | 4 | 5 | 3475 |
| Embodiment 3 | 8 | 4 | 4 | 4 | 4 | 46 | 2966 |
| Embodiment 4 | 10 | 2 | 2 | 2 | 2 | 52 | 3100 |
| Embodiment 5 | 5 | 2 | 2 | 2 | 2 | 30 | 2077 |
| Embodiment 6 | 15 | 4 | 4 | 4 | 4 | 58 | 2664 |

### Embodiment 7 to 10

The difference between Embodiment 7 to 10 and Embodiment 1 is that in step S3, the ratio of the natural bamboo fibers to PP fibers in the composite felt is different from Embodiment 1, and the other steps are basically the same as Embodiment 1, which will not be repeated here. The ratio of the natural bamboo fibers to PP fibers of the composite felt in Embodiment 1 and 7 to 10, as well as the performances of the composites prepared under corresponding conditions, are shown in Table 2. It can be seen from the table that the mixing ratio of bamboo fibers to PP fiber has a significant impact on the product performance. Due to the excellent performance of bamboo fibers, within a certain range (bamboo fibers ratio is less than 50%), the performance of the natural bamboo fiber composite felt becomes better with the increase ratio of the natural bamboo fibers. The bending modulus increases from 1300 Mpa to 3152 Mpa. But when the ratio of the natural bamboo fibers exceeds 50%, the decrease of PP fibers leads to a decrease in a internal adhesion of the composites and a decrease in bending performance.

TABLE 2
Ratio setting of the natural bamboo fibers and PP fibers
in Embodiment 1, 7 to 10 and performance comparison of
composites prepared under corresponding conditions

| | the natural bamboo | bending modulus of composites |
|---|---|---|
| items | fibers:PP Fibers | (Mpa) |
| Embodiment 1 | 5:5 | 3152 |
| Embodiment 7 | 6:4 | 2340 |
| Embodiment 8 | 4:6 | 2905 |
| Embodiment 9 | 3.5:6.5 | 2300 |
| Embodiment 10 | 3:7 | 1998 |

### Comparative Embodiment 1 to 5

The only difference between comparative Embodiment 1 to 5 and Embodiment 1 is that the composition of the treatment solution is different from Embodiment 1, and the other steps are basically the same as Embodiment 1, which will not be repeated here. The composition of the treatment solution in Embodiment 1, comparative Embodiment 1 to 5 and the performance comparison of the composites prepared under corresponding condition are shown in Table 3. From the table, it can be seen that sodium silicate, as a degumming enhancer, can combine with pectin, lignin, and hemicellulose to decompose the gum of bamboo slices. Sodium sulfite and composite sodium phosphate, as antioxidant agents, can prevent the oxidation failure of bamboo fibers. As a bleaching agent, sodium carbonate can remove some pigments from bamboo fibers to achieve the effect of bleaching. The concentration of these inorganic salts also has a significant impact on the mechanical properties of composite materials. It should be noted that the compound sodium phosphate in this part is specifically sodium pyrophosphate.

TABLE 3
Composition of the treatment solution in Embodiment 1, comparative Embodiment 1 to 5
and performance comparison of the composites prepared under corresponding condition

| | sodium | sodium | sodium | composite sodium | sodium | bending modulus |
|---|---|---|---|---|---|---|
| | hydroxide | silicate | sulfite | phosphate | carbonate | of composites |
| items | (g/L) | (g/L) | (g/L) | (g/L) | (g/L) | (Mpa) |
| Embodiment 1 | 12 | 4 | 4 | 4 | 4 | 3152 |
| comparative | 0 | 4 | 4 | 4 | 4 | 712 |
| Embodiment 1 | | | | | | |
| comparative | 12 | 0 | 4 | 4 | 4 | 2439 |
| Embodiment 2 | | | | | | |
| comparative | 12 | 4 | 0 | 4 | 4 | 2608 |
| Embodiment 3 | | | | | | |
| comparative | 12 | 4 | 4 | 0 | 4 | 2615 |
| Embodiment 4 | | | | | | |
| comparative | 12 | 4 | 4 | 4 | 0 | 2998 |
| Embodiment 5 | | | | | | |

The above embodiments are only used to illustrate the technical solution of the present invention and not to limit it. Although the present invention has been described in detail with reference to preferred embodiments, ordinary technical personnel in the art should understand that the technical solution of the present invention can be modified or equivalently replaced without departing from the spirit and scope of the technical solution of the present invention.

What is claimed is:

1. A preparation method of natural bamboo fiber composites, wherein comprising following steps:
S1. preparing a treatment solution including sodium hydroxide, sodium silicate, sodium sulfite, composite sodium phosphate, and sodium carbonate; and
S2. cutting a bamboo into bamboo slices, then soaking the bamboo slices in the treatment solution obtained in step S1 for 5-7 days; taking out the bamboo slices after soaking, immersing in a sodium hydroxide solution with a mass percentage of 4-10%, and heating at 70-100 degree for 1-3 hours; adding an acetic acid to a pH of 6.8-7.2 after heating, taking out the bamboo slices, cleaning and drying, then separating manually to obtain natural bamboo fibers; and
S3. mixing the natural bamboo fibers obtained in step S2 with polypropylene fibers evenly, using a process of opening, carding, lapping and needle-punching to produce a natural bamboo fiber felt material; then laying a fabric on a surface of the natural bamboo fiber felt material, and using a secondary needle-punching process to produce a natural bamboo fiber composite felt; after heating to soft the natural bamboo fiber composite felt, pressing into shape to produce natural bamboo fiber composites.

2. The preparation method of natural bamboo fiber composites according to claim 1, wherein in step S1, a mass concentration of sodium hydroxide in the treatment solution is 8-12 g/L, a mass concentration of sodium silicate is 1-4 g/L, a mass concentration of sodium sulfite is 1-4 g/L, a mass concentration of composite sodium phosphate is 1-4 g/L, and a mass concentration of sodium carbonate is 1-4 g/L.

3. The preparation method of natural bamboo fiber composites according to claim 1, wherein in step S2, an average length of a single bamboo fiber is 150-250 mm, and a diameter is 0.2-0.3 mm.

4. The preparation method of natural bamboo fiber composites according to claim 1, wherein in step S2, a breaking strength of a single bamboo fiber is 2000-3000 Mpa, and an elongation at break is 5-7%.

5. The preparation method of natural bamboo fiber composites according to claim 1, wherein in step S3, a heating temperature is 200-230° C. and a heating time is 3-7 minutes; a mass ratio of the natural bamboo fibers to the polypropylene fibers is 2:3-3:2.

6. The preparation method of natural bamboo fiber composites according to claim 1, wherein in step S3, a pressure during the pressing process is 16-20 Mpa, and a pressing time is 30-50 s.

7. The preparation method of natural bamboo fiber composites according to claim 1, wherein in step S3, a density of the natural bamboo fiber felt material is 600-1200 g/m²; a thickness of the natural bamboo fiber composite felt is 8-15 mm.

8. (canceled)

9. (canceled)
